(19) United States
(12) Patent Application Publication
(10) Pub. No.: US 2025/0204715 A1
(43) Pub. Date: Jun. 26, 2025

(54) Food Preparation Appliance Comprising An Inner Lid

(71) Applicant: SEB S.A., Ecully (FR)

(72) Inventors: Romain Turpin, Ecully Cedex (FR); Johann Petitallot, Ecully Cedex (FR); Frédéric Denis Seurat, Ecully Cedex (FR); Philippe Dumoux, Ecully Cedex (FR)

(73) Assignee: SEB S.A., Ecully (FR)

(21) Appl. No.: 18/851,887

(22) PCT Filed: Mar. 27, 2023
(86) PCT No.: PCT/EP2023/057851

§ 371 Date: Sep. 27, 2024

(30) Foreign Application Priority Data
Mar. 29, 2022 (FR) FR2202787
Mar. 29, 2022 (FR) FR2202788
Feb. 23, 2023 (FR) FR2301679

(51) Int. Cl. A47J 27/08; A47J 27/00; A47J 27/092; A47J 36/10

(52) U.S. Cl. CPC A47J 27/0813; A47J 27/004; A47J 27/092; A47J 36/10

(57) ABSTRACT

A food preparation appliance comprising of:
a housing,
a work bowl, defining a workspace designed to receive food to be prepared,
a main lid, which can be moved between an open position and a closed position to respectively open and close the workspace,
at least one inner lid designed to be reversibly mounted on the main lid and comprising of at least one handling interface to enable a user to grasp or hold the inner lid, characterized in that the handling interface on the inner lid mounted on the main lid is arranged at least partially outside the workspace when the main lid is in the closed position.

### TECHNICAL FIELD OF DISCLOSURE

The present disclosure generally relates to food preparation appliances (for example, household appliances or food processors used to prepare food, in other words, to mix, cut, grate, blend, knead, etc., and/or cook food with or without pressure and/or with or without steam, and/or allow it to simmer, etc.).

### STATE OF THE ART

Food preparation appliances in the prior art commonly include a housing with a work bowl housed in or on the housing to define a workspace, and a main lid which can usually be moved between an open position and a closed position to at least partially open and close the workspace. In the closed position, the lid thus brings the food preparation appliance into a work configuration that enables certain recipes to be made or work operations to be carried out. An additional accessory can be included, such as an inner lid which can be fitted into or coupled with the main lid of the food preparation appliance, providing additional preparation options. However, configuration operations can be tedious and complex, particularly when the user needs to remove the inner lid for the recipe purposes and the lid is hot. Use and/or ergonomics can be degraded when such an inner lid is coupled or uncoupled while still hot and/or soiled with cooking residues or deposits. In particular, if the appliance is used to heat and/or cook food and a subsequent operation or recipe requires the inner lid to be changed, the user has to handle the hot inner lid, exposing him or her to potential burns; otherwise, the user has to wait for the lid to cool before being able to carry out the operation without injury, all of which adversely affects the user experience and/or ergonomics, and/or user safety.

### SUMMARY OF THE DISCLOSURE

One of the purposes of the present disclosure can be to address the aforementioned drawbacks of the prior art and in particular, firstly, to provide a versatile food preparation appliance that can be configured easily, safely and quickly.

To this end, one aspect of the disclosure can relate to a food preparation appliance comprising of:
a housing,
a work bowl, defining a workspace designed to receive food to be prepared,
a main lid, which can be moved between an open position and a closed position to respectively open and close the workspace,
at least one inner lid designed to be reversibly mounted on the main lid and comprising of at least one handling interface to enable a user to grasp or hold the inner lid,
   characterized in that the handling interface on the inner lid mounted on the main lid is arranged at least partially outside the workspace when the main lid is in closed position, and/or the handling interface on the inner lid mounted on the main lid is arranged at least partially outside the general shell of the housing.

According to the above embodiment, the inner lid handling interface is positioned outside the workspace; namely in the ambient atmosphere around the work bowl, or even around the food preparation appliance. As a result, during cooking or heating, the handling interface is not directly exposed to the heat inside the bowl, such that the temperature of the handling interface remains close to the temperature of the room in which the food preparation appliance is located. Handling the inner lid is therefore possible without any risk of burns for the user, since the handling interface is clean and free from cooking spatters even when the main lid is opened right after a cooking or heating cycle.

According to one embodiment, the handling interface can comprise of at least one handle and preferably two handles.

According to one embodiment, the handling interface (and/or one handle) on the inner lid mounted on the main lid comprises of a gripping portion arranged at least 2 cm, preferably at least 3 cm, outside the workspace when the main lid is in the closed position, and/or the handling interface (and/or one handle) on the inner lid mounted on the main lid comprises of a gripping portion arranged at least 2 cm, preferably at least 3 cm, outside a general shell of the housing.

According to one embodiment, the food preparation appliance can be comprised of a means of locking the inner lid to the main lid. The inner lid is thus held in place on the main lid by the means for locking the inner lid to the main lid.

According to one embodiment, inner lid locking means can be located on the handling interface. Ergonomics is enhanced, with the inner lid locking means close to or flush with the handling interface.

According to one embodiment, the inner lid locking means can be located outside the workspace and/or outside the general shell of the housing.

According to one embodiment, the inner lid locking means can comprise of:
two locking devices arranged on either side of one said inner lid and the main lid, and
two counter-forms each opposite each locking device on the other of the inner lid and the main lid. Each locking device can comprise of a latch or hook that can be moved between a release position (the inner lid can be freely removed from the main lid) and an engaged position with the counter-form (the inner lid cannot be freely removed from the main lid). Recoil means can be included to return the latch or hook to the engaged position. A sliding or tilting movement of the latch or hook between the release position and the engaged position can be considered.

According to one embodiment, the main lid can comprise of a lid frame, and the two counter-forms opposite each locking device can be formed by a rim on the lid frame. Such a rim or ridge can also help stiffen the part.

According to one embodiment, the food preparation appliance can comprise of a device for locking the main lid to the housing and/or to the work bowl. Such a device for locking the main lid to the housing and/or to the work bowl enables the closed position to be secured, even if the workspace is pressurized for pressure cooking with steam, for example.

According to one embodiment, the inner lid can comprise of at least one radial bracket support, at least one handling interface, and the main lid locking device can be moved between:
a main lid unlocked position, in which the main lid can be freely moved between its open position and its closed position,
a main lid locked position, in which the main lid can be locked in its closed position,
   and the main lid locking device can comprise of at least one through opening provided to allow said at least one radial bracket to pass through. The through opening makes the handling interface located outside the workspace compatible with the main lid lock on the work bowl or housing to secure the closure of the workspace.

According to one embodiment, the main lid locking device can comprise of a rotatable lock ring comprising of locking teeth arranged to mate with the housing and/or work bowl when the locking device can be in the locked position; at least one through opening can be provided between two locking teeth.

According to one embodiment, in one direction of travel between the main lid locked position and the main lid unlocked position: the through opening can have a passage size greater than or equal to a size of said at least one radial bracket added to a range of travel of the main lid locking device between the main lid unlocked position and the main lid locked position.

According to one embodiment, the main lid locking device can be designed to move between the main lid unlocked position and the main lid locked position according to a rotation around an axial direction of the work bowl. A rotation of around 40° or 20° can be considered.

According to one embodiment, the inner lid can be comprised of a sealing means designed to enable pressure cooking in the workspace closed by the main lid fitted with the inner lid. A lip seal can be provided, for example in polymer and/or in a synthetic material.

According to one embodiment, the sealing means can be arranged between the work bowl and the inner lid mounted on the main lid in the closed position. Sealing is achieved directly between the work bowl and the inner lid, rather than between the work bowl and the main lid: the structure is simpler.

According to one embodiment, the inner lid can be comprised of a pressure control means designed to open a pressure release valve if pressure in the workspace is greater than or equal to a working pressure. Typically, a workspace pressure control valve and a safety valve can be provided to prevent overpressure in the workspace.

According to one embodiment, the main lid can be comprised of a lid heating means designed to heat food received in the workspace when the inner lid is removed from the main lid. Such heating means make it possible to offer the user additional options for cooking and/or heating food. Modularity of use is Enhanced.

According to one embodiment, the food preparation appliance can comprise of a safety device designed to prevent operation of the lid heating means if the inner lid is mounted on the main lid and/or if the main lid is in the open position. Such a safety device can be designed to shut off a power supply circuit to the heating means to prevent any inadvertent operation, particularly if the inner lid is in place and/or if the main lid is not correctly mounted. However, the heating means can be provided on the inner lid.

According to one embodiment, the main lid in the closed position can be arranged to close the workspace at least partially.

Another purpose of the present disclosure can be to provide a versatile food preparation appliance with a work configuration that enables a wide variety of recipes to be made and/or work operations to be carried out.

To this end, another aspect of disclosure can relate to a food preparation appliance comprising of:
a housing,
a work bowl, defining a workspace designed to receive food to be prepared,
a main lid, which can be moved between an open position and a closed position to at least partially open and close the workspace,
a control unit designed to execute a plurality of predetermined food preparation programs,
   characterized in that the food preparation appliance has a plurality of work configurations, at least one work configuration being defined by a reversible coupling of one of the housing and the main lid to an inner lid chosen among at least:
a first inner lid with sealing means and/or pressure control means, so as to enable, for example, the execution of a pressure cooking program, and
a second inner lid with ventilation and/or heating means, so as to enable, for example, the execution of a food preparation program with forced convection heating, each work configuration enabling the execution of at least one predetermined food preparation program among the plurality of predetermined food preparation programs.

According to the above embodiment, the food preparation appliance can be reversibly fitted with an inner lid (i.e., a secondary lid or accessory lid) to bring it into a particular work configuration, thus providing varied and different or specific uses. Thus, a first leakproof inner lid can be provided for pressure cooking. A second inner lid can be provided with heating and/or ventilation means, to offer convective cooking cycles using hot air circulation (to cook fries without frying them, i.e., with little or no oil).

In other words, one aspect of disclosure can relate to food preparation appliance comprising of:
a housing,
a work bowl, defining a workspace designed to receive food to be prepared,
a main lid, which can be moved between an open position and a closed position to at least partially open and close the workspace,
   characterized in that the food preparation appliance comprises of at least two inner lids each designed to be reversibly coupled to one of the housing and the main lid so as to provide, in cooperation with the main lid in the closed position, a predetermined closure of the workspace to enable the execution of a predetermined food preparation program.

In other words, one aspect of the disclosure can relate to a food preparation appliance comprising of:
a housing,
a work bowl, defining a workspace designed to receive food to be prepared,
a main lid, which can be moved between an open position and a closed position to at least partially open and close the workspace,
a control unit designed to execute a plurality of predetermined food preparation programs,
   characterized in that the food preparation appliance comprises of at least two inner lids each designed to be reversibly coupled to one of the housing and the main lid so as to enable, in cohesion with the main lid in the closed position, the execution of a predetermined food preparation program from among the plurality of predetermined food preparation programs.

According to one embodiment, at least one work configuration is defined by a reversible coupling of one of the housing and the main lid to a third inner lid with a feed chute, so as to enable, for example, the execution of a food preparation program with mechanical processing of the food to be prepared.

This feed chute (which goes through the main lid) makes it possible to offer work tools (cutting tools, mixes, choppers, etc.) that the user can safely use. Of course, other inner lids can also be considered for other uses. In any case, the food preparation appliance is easy to use, due to the reversible coupling which also makes it possible to limit complexity with inner lids dedicated to one type of food preparation.

According to one embodiment, the first inner lid can comprise of:
a safety valve, and/or
a sealing gasket designed to fit around the rim of the work bowl, and/or
an opening/closing safety feature, and/or
a pressure control valve. The structural elements required for pressure cooking are combined on the first inner lid, which makes it possible to simplify the structure of the rest of the food preparation appliance.

According to one embodiment, the second inner lid can comprise of at the minimum:
a heating means such as a heating coil, and/or
a fan, and/or
at least one air inlet and/or steam vent chimney, and/or
a viewing window, and/or
a secondary mechanical drive connection interface for connecting the fan to a drive unit on the food preparation appliance, and/or
a secondary electrical connection interface for connecting the heating means to a power supply device on the food preparation appliance. The structural elements required for convection or hot-air cooking in the work bowl (for example, to cook fries without frying) are combined on the second inner lid, which makes it possible to simplify the structure of the rest of the food preparation appliance. It is also possible for the drive unit to be incorporated into the second lid and for this lid to comprise of a second secondary electrical connection interface for connecting the drive unit.

According to one embodiment, the third inner lid can comprise of at least:
a secondary mechanical drive connection interface for connecting a movable work tool with a drive unit on the food preparation appliance, and/or
a through-hole for a movable work tool. The structural elements required for mechanical food processing (with a chopper, knife, press or cutting disc installed in the work bowl) are combined on the third inner lid (along with the feed chute), which makes it possible to simplify the structure of the rest of the food preparation appliance. It is also possible for the drive unit to be incorporated into the third lid and for this lid to comprise of a second secondary electrical connection interface for connecting the drive unit.

According to one embodiment, the secondary mechanical drive connection interface can comprise of:
a pinion, preferably conical, or
a drive sprocket or a U-shaped fork, or
a magnetic coupling.

According to one embodiment, the main lid can comprise of at least:
an upper drive motor with preferably an upper drive shaft, and/or
an upper electrical connection interface, and/or
a free window, and/or
at least one air inlet and/or one air/steam vent, and/or
a sensor, such as a temperature sensor,
a thermal safety device, and/or
an articulating system on the housing, such as a hinge, and/or
a device for locking the main lid on the housing and/or on the work bowl. In addition, the main lid could also be removable. According to these embodiments, the main lid is designed to accommodate any type of inner lid, which makes the basic structure of the food preparation appliance ready for any type of food preparation.

Alternatively, the upper drive motor can be housed in the second inner lid.

In any case, the main lid comprises a mechanical interface for coupling to an inner lid, and/or can comprise of at least one actuator (for example, a motor) for cooperating with a structure on the inner lid (for example, a fan).

According to one embodiment, the main lid locking device can be moved between:
a main lid unlocked position, in which the main lid can be freely moved between its open and closed positions,
a main lid locked position, in which the main lid is locked in its closed position. A lug or hook-on interface can typically be provided on the housing, and a sliding latch on the main lid that can engage or disengage with the lug or hook-on interface.

According to one embodiment, the pressure control valve on the first inner lid can be designed to engage with the air/steam vent on the main lid.

According to one embodiment:
at least one air inlet and/or steam vent on the second inner lid can be designed to engage with the air inlet and/or air/steam vent on the main lid, and/or
the viewing window on the second inner lid can be designed to engage or be opposite the free window on the main lid, and/or
the secondary mechanical drive connection interface on the second inner lid can be designed to engage or be opposite the upper drive motor on the main lid, and/or
a secondary electrical connection interface on the second inner lid can be designed to engage or be opposite the upper electrical connection interface on the main lid.

According to one embodiment:
the feed chute on the third inner lid can be designed to engage or be opposite the free window on the main lid, (so as to go through the main lid) and/or,
the secondary mechanical drive connection interface on the third inner lid can be designed to engage or be opposite the upper drive motor on the main lid, and/or
the through-hole on the third inner lid can be designed to engage or be opposite the upper drive motor on the main lid.

According to one embodiment, the food preparation appliance can be comprised of inner lid locking means on one of the housing and the main lid.

In another instance, the main lid locking device can comprise of at least one cover arranged to at least partially cover the inner lid locking means, when the main lid locking device is in the main lid locking position. Thus, the main lid locking device prevents manipulation of the inner lid locking means when the main lid is in the closed and locked position.

According to one embodiment, the food preparation appliance can comprise of heating and/or cooking means.

According to one embodiment, the food preparation appliance can comprise of at least one movable work tool and/or a lower motor for rotating a movable work tool. Typically, the lower motor can be housed in the housing and a through-hole can be provided in the work bowl for a drive member, drive shaft or part of the work tool.

According to one embodiment, the food preparation appliance can comprise of steam-generating means, preferably pressurized steam-generating means. Water storage and heating means can be provided.

According to one embodiment, the food preparation appliance can comprise of at least one human-machine interface designed to enable the selection of a food preparation program.

According to one embodiment, the food preparation appliance can comprise of detection and/or foolproofing means, designed to detect or foolproof the inner lid and/or the type of inner lid.

According to one embodiment, the food preparation appliance can be comprised of detection and/or foolproofing means, designed to detect or foolproof the inner lid and/or the type of inner lid, and in which the control unit is designed to offer, depending on the detected and/or fool-proofed inner lid, a control interface suitable for configuring the appliance, for example a recipe program filtered from a recipe library.

According to one embodiment, the food preparation appliance can be comprised of control means designed to execute a food preparation program.

According to one embodiment, the inner lid can be designed to reversibly couple with the main lid.

Another purpose of the present disclosure can be to offer a versatile food preparation appliance that can be configured easily, safely and quickly.

To this end, another aspect of the disclosure can relate to a food preparation appliance comprising of:
a housing,
a work bowl, defining a workspace designed to receive food to be prepared,
a main lid, which can be moved between an open position and a closed position to respectively at least partially open and close the workspace,
at least one inner lid designed to be reversibly mounted on the main lid
means of locking the inner lid to the main lid, characterized in that the means of locking the inner lid to the main lid are arranged outside the workspace.

According to the above embodiment, the food preparation appliance comprises of at least one removable inner lid, which enables at least one configuration for a specific recipe or food preparation. The inner lid can be reversibly coupled to the main lid, and means of locking the inner lid to the main lid are arranged outside the workspace, which makes the food preparation appliance easier to use. This means that the cooking and/or preparation steps can be carried out quickly using the different lids, without the risk of the user burning himself or herself when removing an inner lid that might still be hot or getting dirty when handling an area on an inner lid that might have been spattered.

According to one embodiment, the inner lid locking means are arranged on the outside of the main lid.

According to one embodiment, the work bowl comprises of a side wall arranged between the workspace and the inner lid locking means.

According to one embodiment, the inner lid locking means are separated from the workspace by at least one partition on the work bowl, and/or at least one partition on the housing, and/or at least one partition on the main lid.

According to one embodiment, the inner lid locking means comprises of:
at least one locking device with a movable latch arranged on one of the inner lid and the main lid, the movable latch being movable between a locked position in which the inner lid can be locked to the main lid and an unlocked position in which the inner lid can be freely mounted on or removed from the main lid,
at least one counter-form arranged on the other of the inner lid and the main lid to engage with the movable latch in the locked position to lock the inner lid to the main lid.

According to one embodiment, the latch device can comprise of a control trigger designed to be actuated by a user and connected to the movable latch. The control trigger makes the locking mechanism easier to use.

According to one embodiment, the locking device can comprise of a frame formed on said one of the inner lid and the main lid.

According to one embodiment, the control trigger can be slidably mounted in the frame. Mounting is easy and use is intuitive: the trigger is simply pulled or slid.

According to one embodiment, the inner lid locking means comprise of a handling interface designed to enable a user to hold the inner lid.

According to one embodiment, the handling interface comprises of a portion of the control trigger and a portion of the frame to be pinched together.

According to one embodiment, the movable latch can be pivotally mounted on said one of the inner lid and the main lid. Assembly is easy.

According to one embodiment, the latch device can comprise of at least one resilient member, such as a spring, designed to push the movable latch into a locked position. Return to the locked position is automatic, which makes the locking means easier to use.

According to one embodiment, the movable latch and/or the counter-form can comprise of at least one slope or lead-in chamfer to facilitate automatic movement of the movable latch to the unlocked position when mounting the inner lid on the main lid. Mounting the inner lid automatically causes the movable latch to move to the unlocked position, which makes the locking means easier to use.

According to one embodiment, the locking device can be ear-shaped or handle-shaped on said one of the inner lid and the main lid. This makes handling easier.

According to one embodiment, the food preparation appliance can comprise of:
two locking devices arranged on either side of said one of the inner lid and the main lid, and
two counter-forms each opposite each locking device on the other of the inner lid and the main lid.

According to one embodiment, the main lid can comprise of a device for locking the main lid to the housing and/or the work bowl.

According to one embodiment, the main lid locking device can be moved between:
a main lid unlocked position, in which the main lid can be freely moved between its open position and its closed position,
a main lid locked position, in which the main lid can be locked in its closed position,
   and the main lid locking device can comprise of at least one cover arranged to at least partially cover the inner lid locking means when the main lid locking device is in the main lid locked position. Thus, the main lid locking device prevents manipulation of the inner lid locking means when the main lid is in the closed and locked position.

According to one variant, the main lid locking device can be rotationally or translationally moved.

According to one embodiment, the food preparation appliance can be comprised of inner lid guide means, designed to guide the inner lid to a mounted position on the main lid.

According to one embodiment, the inner lid guide means can be designed to guide the counter-form towards the movable latch. A flared groove can be provided to gradually guide the counter-form.

### DESCRIPTION OF THE FIGURES

Other features and advantages of the present disclosure will become more apparent from the following detailed description of embodiments of the disclosure, provided by way of non-limiting example and illustrated in the appended figures, in which:

FIG. 1 is a general isometric view of a first variant of a food preparation appliance comprising of a housing and a main lid;

FIG. 2 is an exploded perspective view from under the main lid in FIG. 1 to show an inner lid;

FIG. 3 is a detail from FIG. 2 to show means for locking the inner lid to the main lid;

FIG. 4 is a cross-section of the food preparation appliance in FIG. 1 to show the main lid in a closed position on the housing and closing a workspace defined by a work bowl on the housing;

FIG. 5 is a view from under the food preparation appliance in FIG. 1, without the housing but with the work bowl, to show a device for locking the main lid to the housing and/or the work bowl, in an unlocked position;

FIG. 6 is the view in FIG. 5, to show the device for locking the main lid to the housing and/or to the work bowl, in a locked position;

FIG. 7 is a perspective view of a second variant of a food preparation appliance, comprising of a housing, an open main lid and three inner lids which can mate with the main lid;

FIG. 8 is a perspective top view of the food preparation appliance in FIG. 7 with the main lid closed;

FIG. 9 is a perspective top view of the main lid of the food preparation appliance in FIG. 7;

FIG. 10 is a perspective view from under the main lid of the food preparation appliance in FIG. 7;

FIG. 11 is a perspective view from under a first inner lid of the food preparation appliance in FIG. 7;

FIG. 12 is a perspective top view of a second inner lid of the food preparation appliance in FIG. 7;

FIG. 13 is a perspective view from under the second inner lid of the food preparation appliance in FIG. 7;

FIG. 14 is a perspective top view of a third inner lid of the food preparation appliance in FIG. 7;

FIG. 15 is an exploded view of a device for locking an inner lid to the main lid of the food preparation appliance in FIG. 7;

FIG. 16 is another view of the device for locking an inner lid to the main lid of the food preparation appliance in FIG. 7;

FIG. 17 is a first variant of a drive unit that can be housed in the main lid of the food preparation appliance in FIG. 7;

FIG. 18 is a second variant of a drive unit that can be housed in the main lid of the food preparation appliance in FIG. 7;

FIG. 19 is a third variant of a drive unit that can be housed in the main lid of the food preparation appliance in FIG. 7.

### DETAILED DESCRIPTION OF EMBODIMENT(S)

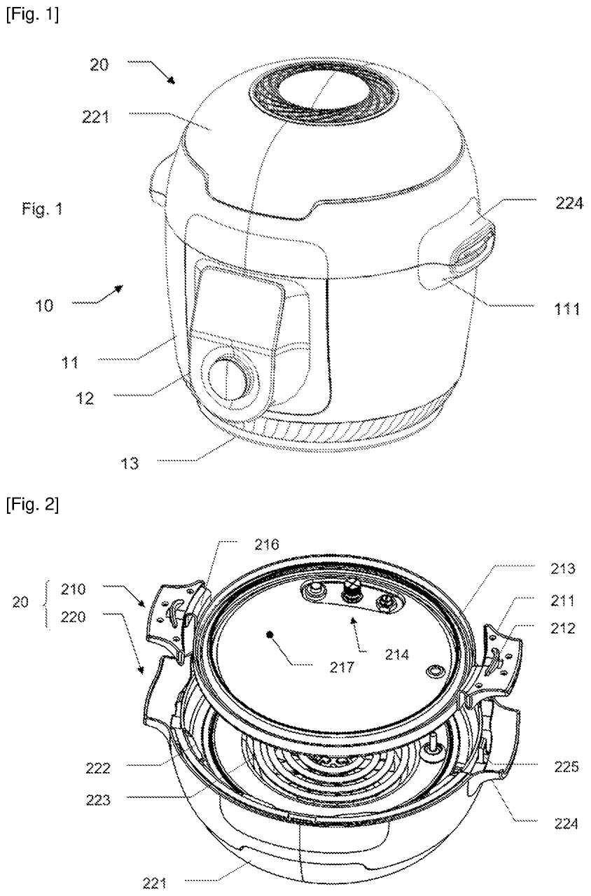

FIG. 1 is a general isometric view of a food preparation appliance comprising of a housing 10 and a main lid 20 covering the housing 10. The food preparation appliance comprises of a work bowl 13 (shown in FIG. 4) housed in the housing 10 for preparing and cooking food.

For example, the food preparation appliance can be a pressure cooker, a rice cooker or a food preparation appliance that can combine several cooking modes. The food preparation appliance can comprise of heating means in the housing 10 and/or in the main lid 20 for heating and/or cooking the food received in the work bowl 13; a pressure cooking program can be provided; a hot-air and/or convection cooking program can be provided directly in the work bowl 13; and a cooking program can be provided by heating the wall of the work bowl 13. Optionally, work means (such as a knife, a rotary chopper, a mixing or kneading paddle, etc.) can be provided in the work bowl 13.

The housing 10 contains, in particular a base 13, a human-machine interface 12 for controlling the food preparation appliance and a side wall 11 fitted with housing handle covers 111. The main lid 20 itself comprises of an upper wall 221 fitted with lid handle covers 224. As seen in FIG. 1, the main lid 20 comprises of a ventilation grid on its upper part as an air intake and/or for venting hot air and/or cooking vapors. Other openings can be provided in the main lid 20.

To enable the various cooking modes described above, the main lid 20 can be provided with a removable inner lid. In particular, several removable inner lids can be provided, each designed to couple to the main lid 20 to provide a specific cooking mode or a specific configuration. As shown in FIG. 2, the main lid 20 contains, in particular a lid called frame 220 and an inner lid 210, which can be removed relative to the lid frame 220. However, one or more specific cooking modes can also be enabled with the main lid 20 without the inner lid 210.

The lid frame 220 contains in particular the upper wall 221 fitted with lid handle covers 224, lid heating means 223, a toothed lock ring 222, and a catch or counter-form 225.

In this example, the inner lid 210 is provided to configure the food preparation appliance to offer a pressure cooking program. The inner lid 210 contains in particular a main wall 217, pressure control means 214, sealing means (a gasket 213), a handling interface formed in this case by handles 221 connected to the main wall 217 by radial brackets 216. The handles 211 have triggers 212.

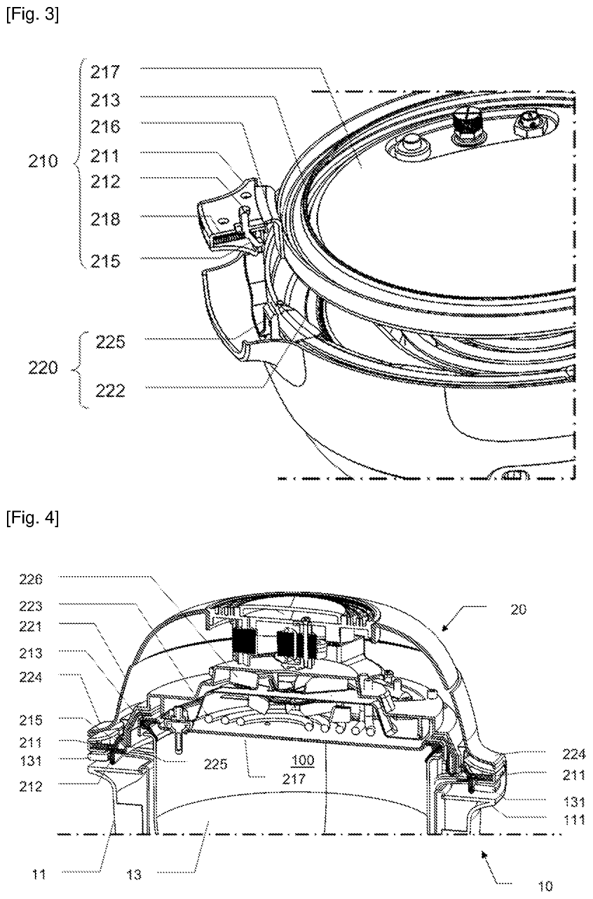

As shown in FIG. 3, the triggers 212 are formed in a single piece with latches 215 and housed in handles 211 in a slide connection, with a spring 218 that pushes the latches 215 towards the inside of the food preparation appliance. The latches 215 are meant to be opposite the counter-forms 225 on the lid frame 220, and sliding the triggers 212 in the handles 211 makes it easy to lock or unlock the inner lid 210 on the main lid 20 (via the lid frame 220).

Whereas FIGS. 2 and 3 show the inner lid 210 separated from lid frame 210, FIG. 4 shows the inner lid 210 docked and locked to the lid frame 210.

Indeed, FIG. 4 shows the main lid 20 mounted on the housing 10. The cross-sectional view in FIG. 4 shows the work bowl 13 housed, for example, in an outer bowl forming a side wall 11 and secured in or on housing 10, covered by the main wall 217 and defining a workspace 100. As a variant or in addition, a double-walled work bowl can be provided.

It can be seen in FIG. 4 that the main lid 20 also comprises of ventilation means 226 typically comprising of a motor for rotating a fan fitted with blades, or comprising of fan vanes or louvers, and arranged above the lid heating means 223. In this FIG. 4, the inner lid 210 is coupled and locked to the main lid 20. In fact, the latches 215 are engaged in the counter-forms 225. As a result, the inner lid 210 is attached to the main lid 20 (via the lid frame 220). Thus, in the configuration shown, the gasket 213 can fit around the upper rim of the work bowl 13 to ensure a good seal and offer a pressure cooking mode.

It should be noted that the work bowl 13 comprises of bowl handles 131 arranged below the handles 211, all of which are housed between the lid handle covers 224 and the housing handle covers 111. In particular, it should be noted that the bowl handles 131 form stops for the triggers 212, so that in the work configuration shown in FIG. 4, it is impossible to unlock the inner lid 210 on the main lid 20. User safety is improved.

It should also be noted in FIG. 4 that the handles 211 are provided outside the workspace 100 and/or even outside the generally cylindrical shell of the side wall 11 of the housing 10. Similarly, it should be noted in FIG. 4 that the inner lid locking means (triggers 212, latches 215, counter-forms 225) are provided outside the workspace 100 and/or even at least partially outside the generally cylindrical shell of the side wall 11 of the housing 10.

As a result, the handles 211 and/or triggers 212 are located away from the workspace 100 that is heated and/or engulfed with cooking vapors, so that the handling interfaces on the main lid 20 and particularly on the inner lid 210 (the handles 211) remain cool and/or unaffected by cooking vapors. Handling the inner lid 210 is safe, and there is less burn risk for the user, who can easily change the inner lid 210 immediately after opening the main lid 20, for example during food preparation to switch from one configuration of the food preparation appliance to another configuration.

Moreover, in this pressure cooking mode, the lid heating means 223 and the ventilation means 226 are deactivated to prevent inadvertent heating, and means can be provided to detect the presence and/or type of inner lid 210 (switches, optical sensors, etc. can be used), to prevent or enable operation of the lid heating means 223 and/or of the ventilation means 226 specifically depending on the presence and/or type of inner lid 210.

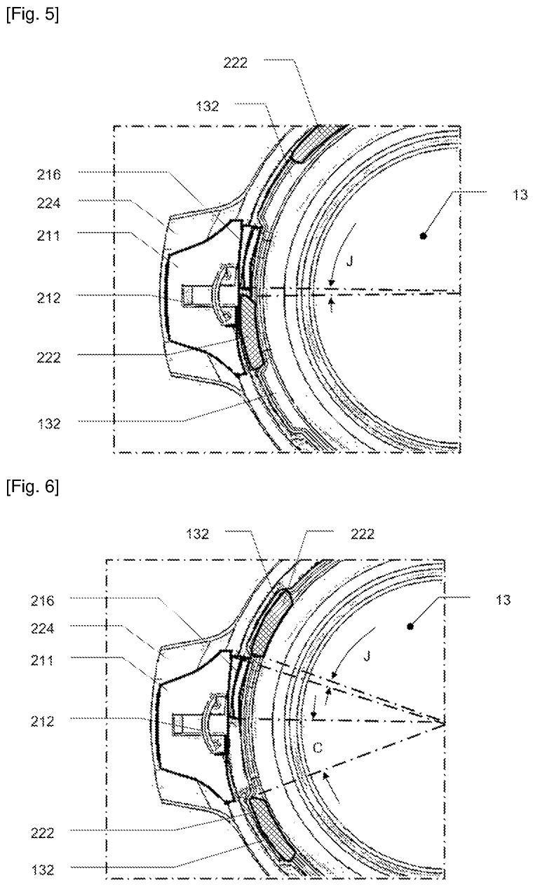

FIGS. 5 and 6 show a view from under the food preparation appliance in FIG. 1, without the housing 10 but with the work bowl 13, to show a device for locking the main lid 20 to the housing 10 and/or the work bowl 13.

As mentioned above and shown in FIGS. 2 and 3, the main lid 20, and the lid frame 220 in particular, comprise of a toothed lock ring 222, designed to be pivotally connected relative to the lid frame 220. On the side of the housing 10, the outer bowl forming the side wall 11 has a toothed or serrated upper rim, and when the main lid 20 is in the closed position, the toothed lock ring 222 can then be pivoted so that its own teeth engage with teeth 132 on the outer bowl, such that the main lid 20 is then locked onto the outer bowl and thereby onto the housing 10 and onto the work bowl 13.

The teeth of the toothed lock ring 222 and/or the teeth 132 on the work bowl 13 can be slanted or have a slope along the relative direction of travel between the parts to facilitate their relative engagement at the start of the locking movement, and/or to bring the main lid 20 into a final locked position which ensures compression of the gasket 213.

More specifically and in FIG. 5, the locking device on the main lid 20 on the housing 10 (in particular on the outer bowl) and/or on the work bowl 13 is in a main lid unlocked position, in which the main lid 20 can be freely moved between its open and closed positions. In fact, as can be seen in FIG. 5 the cross-hatched teeth on the toothed lock ring 222 disengaged from the teeth 132 on the outer bowl. It should also be noted that the lower tooth of the toothed lock ring 222 is separated by gap J from the radial bracket 216 on the inner lid 210. The gap J can even be zero if the toothed lock ring 222 is designed to abut the radial bracket 216 on the inner lid 210.

In FIG. 6, the locking device on the main lid 20 on the housing 10 and/or on the work bowl 13 is in a main lid locked position, in which the main lid 20 is locked in its closed position. Indeed, as can be seen in FIG. 6, the toothed lock ring 222 has rotated (relative to the configuration in FIG. 5) in a counter-clockwise direction over a range C, so that the cross-hatched teeth of the toothed lock ring 222 are engaged with the teeth 132 of the outer bowl. It should also be noted that the upper tooth of the toothed lock ring 222 is separated by a gap J from the radial bracket 216 on the inner lid 210. The gap J can be zero if the toothed lock ring 222 is designed to abut the radial bracket 216 on the inner lid 210.

It should therefore be noted that the toothed lock ring 222 comprises of a gap between at least two of its teeth to allow the radial bracket 216 to pass through. In other words, it should be noted that the space between two teeth on the lock ring 222 enables the lock ring 222 to rotate from stop to stop with the radial brackets 216 connecting handles 211 to the main wall 217 of the inner lid 210.

It should be noted that on housing 10, the locking teeth are provided in this example on the outer bowl forming the side wall 11, but these locking teeth can also be provided directly on the work bowl 13, or on another part attached to the housing 10.

It will be understood that various modifications and/or improvements that are obvious for the person skilled in the art may be made to the different embodiments of the disclosure described in this description without departing from the scope of the disclosure of the first variant described above with reference to FIGS. 1 to 6.

In particular, it should be noted that triggers and locks can be provided in several parts, and/or mounted according to other kinematics (pivoting, hinged, etc.).

Other heating means and/or heating technologies can also be considered. Any type of articulation or mounting of the main lid on the housing can be used (hinged, pivoting, with a lever, with a deformable parallelogram, etc.). Other means of locking the main lid to the housing can also be considered, such as a main lid locking device that can be rotationally or translationally moved, in particular with clamps arranged on the main lid 20 that do not obstruct the passage of the handling interface on the at least one inner lid 210.

In the example shown, the inner lid can be provided to configure the food preparation appliance to offer a pressure cooking program. Other types of inner lids can be provided to offer other uses. An inner lid can be designed to direct a flow of hot air into a specific part of the work bowl; an inner lid can be designed with a chute to allow food to be added during cooking, etc. In this case, the members of the main lid 20 can be designed to leave a passage for such a chute. In particular, such a chute can be offset relative to the heating means, and/or to the ventilation means, and/or to the main lid locking means. In other words, the heating means, and/or the ventilation means, and/or the main lid locking means can be designed and/or arranged in the main lid 20 to leave a passage for a through-chute.

In addition, although the main lid can be moved between an open position and a closed position to respectively open and close the workspace, it is not necessarily connected to housing 10 and could be removable from the housing 10. In this case, a first electrical connector can be provided on the main lid and arranged to interact with a second electrical connector on the housing to power and control the electrical elements on the main lid, such as the heating and/or ventilation means.

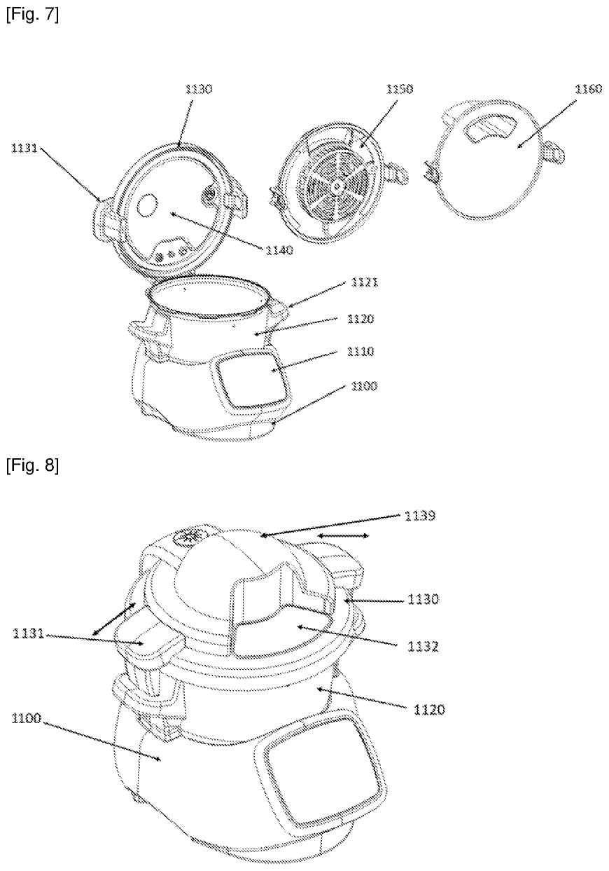

FIG. 7 is a perspective view of a second variant of a food preparation appliance comprising of:
a housing 1100, which can otherwise be called an outer bowl, with a human-machine interface 1110 (here a screen, but control buttons can also be considered),
a work bowl 1120 defining a workspace in which food can be prepared and a work tool can optionally be placed, the work bowl 1120 being removable and/or lockable to the housing 1100 in a known manner,
a main lid 1130, here open, which can pivot around a hinge anchored to housing 1100 to occupy the open position as in FIG. 7 or a closed position as in FIG. 8,
three inner lids each of which can be reversibly coupled to the main lid, comprising of a first inner lid 1140 (coupled to the main lid 1130), a second inner lid 1150 and a third inner lid 1160.

According to a variant, the main lid may not be hinged to the housing 1100, but can be removed.

Typically, the food preparation appliance can also comprise of, in the housing 1100, heating means, one or more drive motors, a control unit, drive means provided to connect a drive motor on the housing 1100 to a movable work tool housed in the work bowl 1120, etc. It should also be noted in FIG. 7 that the work bowl 1120 comprises of handles 1121 for easy handling by a user, and that the main lid 1130 comprises of a device 1131 for locking the main lid 1130 to the work bowl 1120, as will be explained with reference to FIG. 8.

As will be explained below:
the first inner lid 1140 enables the food preparation appliance to be brought into a first configuration for pressure cooking,
the second inner lid 1150 enables the food preparation appliance to be brought into a second configuration for forced convection or hot-air cooking,
the third inner lid 1160 enables the food preparation appliance to be brought into a third configuration enabling food to be introduced into the bowl through a chute when the main lid is in the closed position, so as to mechanically process the food with a movable work tool housed in the work bowl 1120. In fact, the first inner lid 1140, the second inner lid 1150 and the third inner lid 1160 can be interchanged to bring the food preparation appliance to a particular configuration for specific recipes or preparations.

FIG. 8 is a perspective top view of the food preparation appliance in FIG. 7 with the main lid 1130 closed on the work bowl 1120. A trim 1139 partially covers the main lid 1130, and FIG. 8 shows a free window 1132 along with the locking device 1131 on the main lid 1130 on the work bowl 1120, which can translationally slide or move to lock/unlock the main lid 1130 on the housing 1100 and/or on the work bowl 1120.

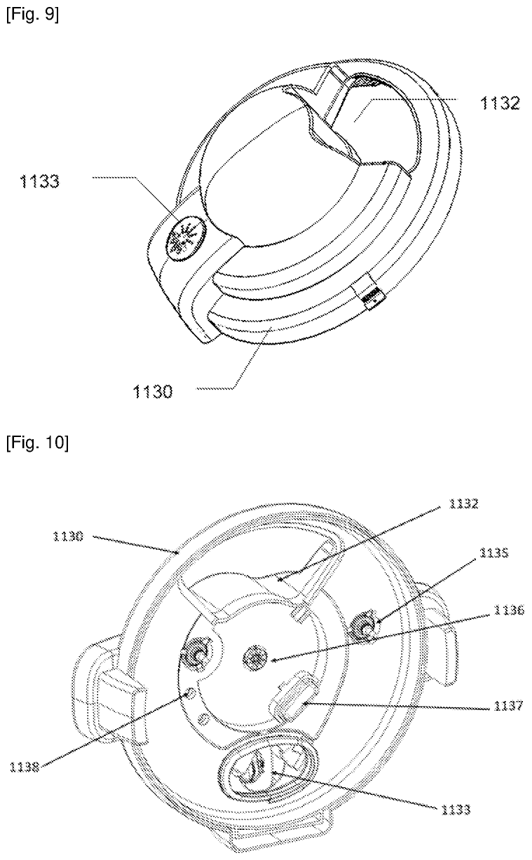

FIG. 9 is a perspective top view of the main lid 1130 of the food preparation appliance in FIG. 7, without the trim 1139 shown in FIG. 8. In particular, the main lid 1130 comprises of the free window 1132, which is an oblong or bean-shaped through-port, and an air/steam vent 1133.

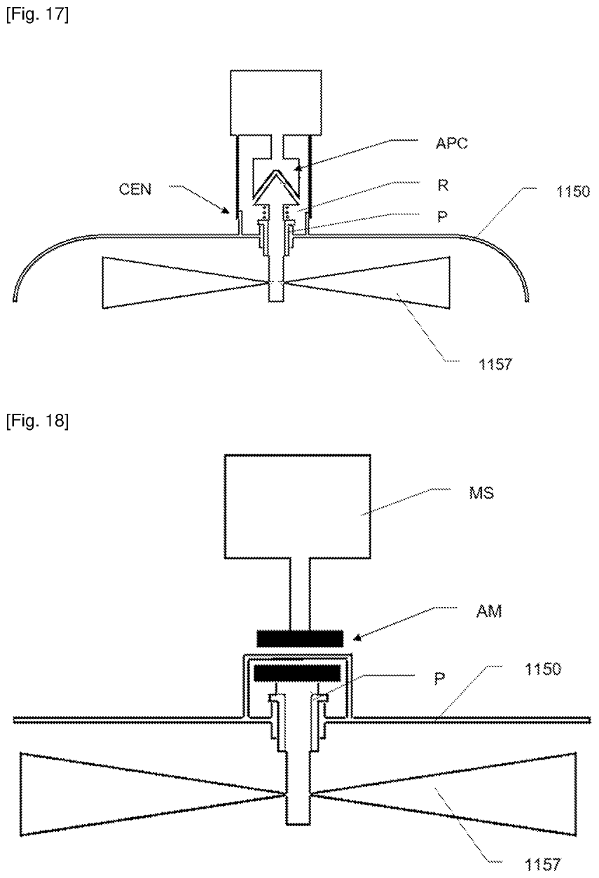

FIG. 10 is a perspective view from under the main lid 1130 of the food preparation appliance in FIG. 7. The underside of the main lid 1130 is equipped with two temperature sensors 1135, a drive shaft 1136; since an MS upper motor (illustrated in FIGS. 17 to 19) is housed in the main lid 1130, a thermal safety device 1137 and an upper electrical connection interface 1138. FIG. 10 also shows the free window 1132 and the air/steam vent 1133.

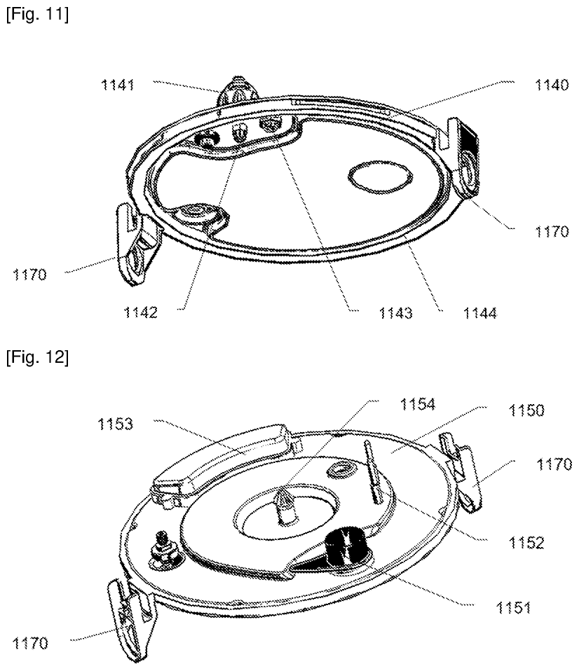

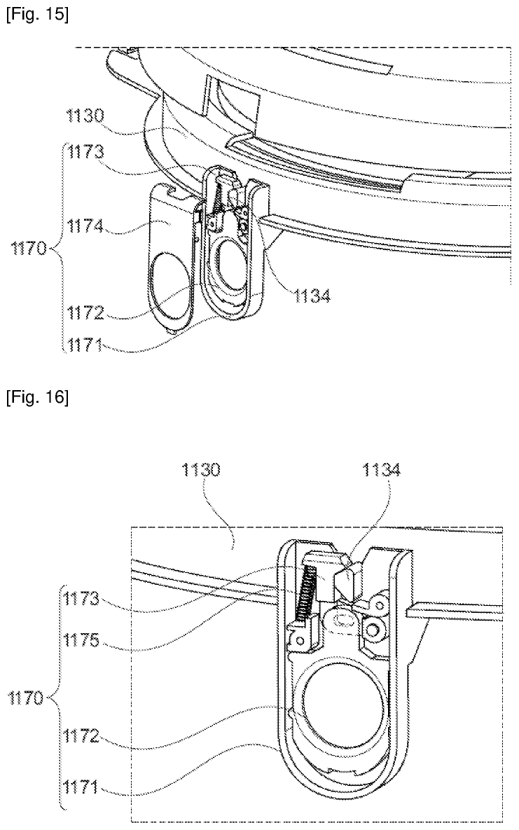

FIG. 11 is a perspective view from under a first inner lid 1140 of the food preparation appliance in FIG. 7. Like the second inner lid 1150 and the third inner lid 1160, the first inner lid 1140 comprises of two inner lid locking devices 1170 on the main lid 1130, which are described in detail in FIGS. 15 and 16. The general principle of the two inner lid locking devices 1170 on the main lid 1130 is to enable easy reversible coupling, in this case by a self-returning mechanism that engages on anchors on the main lid 1130.

Each of the inner lid locking devices 1170 is arranged outside the workspace to enable a user to lock or unlock an inner lid 1140, 1150, 1160 without having to touch a surface of the inner lid opposite the workspace when the main lid is locked to the housing 1100 and/or the work bowl 1120.

In addition, the first inner lid 1140 is designed to couple with the main lid 1130 to enable pressure cooking. To this end, the first inner lid 1140 comprises of a pressure control valve 1141, an opening/closing safety feature consisting of an Aroma finger-type manometric rod system 1142, a safety valve 1143, and a sealing gasket 1144 arranged to fit around the rim of the work bowl 1120. Thus, when the first inner lid 1140 is coupled to the main lid 1130, the assembly covers the work bowl 1120 to provide a hermetic closure, thus forming a pressurizable workspace.

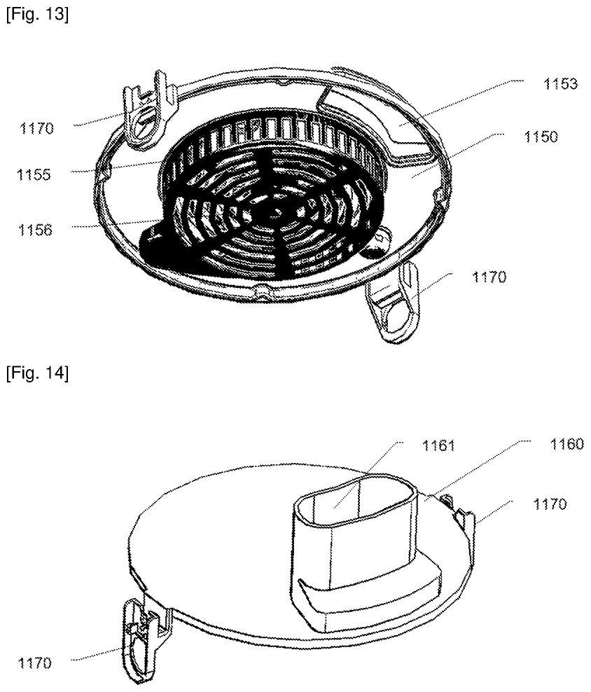

FIG. 12 is a perspective top view of a second inner lid 1150 of the food preparation appliance in FIG. 7. FIG. 13 is a perspective view from under the second inner lid 1150 of the food preparation appliance in FIG. 7. The second inner lid 1150 is designed to couple with the main lid 1130 for convection or hot-air cooking of food placed in the work bowl 1120. To this end, the second inner lid 1150 comprises of:
a heating means such as a heating coil 1156,
a fan 1157 (illustrated in FIGS. 17 to 19),
a steam vent 1151 which can act as an air inlet/vent (cold air inlet, hot air vent) in a convection cooking mode of the “air fryer” type, it being understood that two separate or combined openings can be provided as shown here,
a viewing window 1153 for viewing the inside of the work bowl 1120 to monitor cooking,
a secondary mechanical drive connection interface 1154 for connecting the fan 1157 to a drive unit on the food preparation appliance, and/or
a secondary electrical connection interface 1152 for connecting the heating coil 1156 to a power supply unit on the food preparation appliance. It should be noted that, in particular, the secondary mechanical drive connection interface 1154 and the secondary electrical connection interface 1152 are arranged opposite the drive shaft 1136 and the upper electrical connection interface 1138, respectively.

Thus, when the second inner lid 1150 is coupled to the main lid 1130, the assembly covers the work bowl 1120 to generate a flow of hot air that can be blown or projected towards the food placed in work bowl 1120. In addition, the work bowl 1120 can be fitted with a stirring tool for oil-free frying, for example. In such a case, the work bowl 1120 can comprise of a through opening, and the work bowl 1120 and/or work tool can be equipped with sealing means to enable pressure cooking. Alternatively, a magnetic couple can be provided to drive the stirring tool without requiring a through opening in the cooking bowl 1120.

FIG. 14 is a perspective top view of a third inner lid 1160 of the food preparation appliance in FIG. 7. The third inner lid 1160 is designed to couple with the main lid 1130 to enable mechanical processing of food placed in work bowl 1120, which also comprises of a movable work tool, such as a knife, chopper, press or cutting disc, etc. To this end, to ensure safe use, the third inner lid 1160 contains in particular a feed chute 161 designed to pass through the free window 1152 of the main lid 1130, and which enables food to be introduced into the work bowl 1120, while preventing a user from being able to reach the movable work tool. Thus, when the third inner lid 1160 is coupled with the main lid 1130, the assembly covers the work bowl 1120, enabling food to be processed safely in the work bowl 1120. As a variant, the work tool could be driven by a drive unit arranged in the main lid 1130, in particular the same as the one driving the fan in the second lid 1150, or in the third lid 1160. The movable work tool could also be driven from under the work bowl 1120 through the bottom [base].

FIGS. 15 and 16 show a detailed view of the device 1170 for locking an inner lid to the main lid 1130 of the food preparation appliance in FIG. 7. The device 1170 for locking the inner lid to the main lid 1130 consists in particular of:
a locking device with a movable latch 1173 and a control trigger 1172,
a resilient member, in this case a compression spring 1175, that pushes the movable latch 1173 into a locked position as shown in FIGS. 15 and 16,
a frame 1171, which houses the movable latch 1173, the control trigger 1172 and the compression spring 1175,
a cap 174 that can be attached to the frame 1171 to cover and conceal the locking members, namely the movable latch 1173, the control trigger 1172 and the compression spring 1175.

On the main lid 1130, a counter-form 1134 protrudes to engage with the movable latch 1173. The movable latch 1173 is pivotally mounted on the frame 1171, and can be moved between:
the locked position shown in FIGS. 15 and 16, in which the first, second or third inner lid 1140, 1150, 1160 can be locked to the main lid 1130, and
an unlocked position, in which the first, second or third inner lid 1140, 1150, 1160 can be freely mounted on or removed from the main lid 1130.

The control trigger 1172 is slidably mounted between the frame 1171 and cap 174, and is attached to the movable latch 1173 so that it can be moved from the locked position to the unlocked position. A user can thus easily unlock the system and uncouple the first, second or third inner lid 1140, 1150, 1160 from the main lid 1130.

The compression spring 1175 fitted between the frame 1171 and the movable latch 1173 pushes the latter from the unlocked position into the locked position. The system is then automatically returned to the locked position by default. Lead-in chamfers are provided on the movable latch 1173 and on the counter-form 1134 to enable the movable latch 1173 to move automatically from the locked position to the unlocked position when the first, second or third inner lid 1140, 1150, 1160 is coupled to the main lid 1130. Installation is therefore easy: the user simply pushes the first, second or third inner lid 1140, 1150, 1160 onto the main lid 1130. Lastly, it should be noted that the frame 1171 forms an upwardly-flared receiving groove for receiving and guiding the counter-form 1134 when mounting the first, second or third inner lid 1140, 1150, 1160 on the main lid 1130.

To summarize, the food preparation appliance can be reversibly fitted with one of the first, second or third inner lids 1140, 1150, 1160, so as to be equipped with the appropriate structure for carrying out specific steps in a recipe or for processing food in the work bowl 1120. Configuration is easy: the user simply pushes one of the first, second or third inner lids 1140, 1150, 1160 onto the main lid 1130 to clip, lock or fasten it. To remove the first, second or third inner lid 1140, 1150, 1160, the user simply pulls the control trigger 1172.

To perform these locking and unlocking operations, the user does not need to touch the surface of the inner lid opposite the workspace when the main lid 1130 is locked to the housing 1100 and/or to the work bowl 1120.

Thus, when the user needs to remove the inner lid for recipe purposes and the lid is hot, which may be the case for the first inner lid 1140 or the second inner lid 1150, the user does not run the risk of burning his or her fingers and does not need to wait for one inner lid to cool before being able to replace it with another inner lid. As for the third inner lid 1150, the user will not get his or her fingers dirty with any splatters that might cover all or part of the surface of the third inner lid 1160 opposite the workspace when the main lid 1130 is locked to the housing 1100 and/or to the work bowl 1120.

It should be noted that the device 1131 for locking the main lid 1130 to the housing 1100 and/or to the work bowl 1120 can slide to lock/unlock the main lid 1130 on the housing 1100 and/or on the work bowl 1120. The locking device 1170 can be placed in a position that is covered or concealed by the locking device 1131 on the main lid 1130 of the work bowl 1120, when it locks the main lid 1130 to the work bowl 1120. For example, a sliding clamp on locking device 1131 on the main lid 1130 on the housing 1100 and/or on the work bowl 1120 can form a cover that covers the inner lid locking device 1170 on the main lid 1130. As a result, when the appliance is running (main lid 1130 locked to the housing 1100 and/or to the work bowl 1120), it is impossible to access or handle the inner lid locking device 1170 on the main lid 1130. Safety and ergonomics are improved.

FIGS. 17 to 19 show variants of the coupling between the main lid 1130 and particularly the second inner lid 1150. Indeed, the latter can comprise of fan 1157 and an MS upper motor can be provided or housed in the main lid 1130 to drive the fan 1157.

To this end, FIG. 17 is the first variant of a drive unit that can be housed in the main lid 1130 of the food preparation appliance in FIG. 7. In this first variant, a bevel gear coupling APC is provided. A male bevel gear (here attached to the second inner lid 1150) is opposite a female bevel gear to transmit the rotational torque of the MS upper motor to the fan 1157, mounted on a bearing P. Of course, the male bevel gear and the female bevel gear can be reversed. An R spring can be provided to compensate for manufacturing tolerances and ensure tooth engagement, and a CEN centering system can also be provided between the main lid 1130 and the second inner lid 1150. The CEN centering system typically involves an index and a receiving indentation (in this case two cylindrical shapes), but guide chamfers or any other shape can also be provided.

FIG. 18 is a second variant of a drive unit that can be housed in the main lid of the food preparation appliance in FIG. 7. In this second variant, an AM magnetic coupling is provided between the main lid 1130 and the second inner lid 1150. The advantage of this solution is being able to provide a leakproof system that is less susceptible to misalignment between the main lid 1130 and the second inner lid 1150. More specifically, the fan 1157, mounted on the bearing P of the second inner lid 1150, comprises of a first magnet, which is opposite a second magnet attached to the drive shaft MS of the upper motor attached to the main lid 1130.

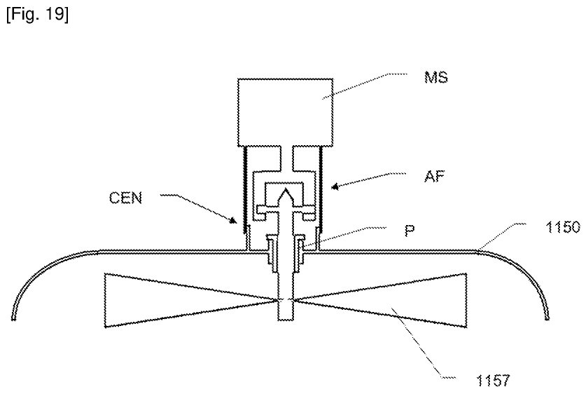

FIG. 19 shows a third variant of a drive unit that can be housed in the main lid of the food preparation appliance in FIG. 7. In this third variant, quite similar to the first variant in FIG. 17, a coupling to fork AF is provided between the main lid 1130 and the fan 1157, mounted on the bearing P of the second inner lid 1150. More specifically, a fork attached to the MS upper motor is engaged with a fan Tee 1157. Of course, the fork and Tee can be reversed. A CEN centering system is also provided to ensure correct alignment between the fork attached to the MS upper motor and the fan Tee 1157.

It will be understood that various modifications and/or improvements that are obvious for the person skilled in the art may be made to the different embodiments of the disclosure described in this description without departing from the scope of the disclosure of the second variant described above with reference to FIGS. 7 to 19.

In particular, it should be noted that:
the first, second or third inner lid 1140, 1150, 1160 is attached to the main lid 1130, but can also be reversibly attached to the work bowl 1120 or to the housing 1100,
the work bowl 1120 can be removably or permanently attached to the housing 1100, and/or an outer bowl can be provided, attached to or forming part of the housing,
the first, second or third inner lid 1140, 1150, 1160 can comprise of structural elements other than the ones described. In particular, a fan (rotated by a fan motor and fitted with blades, or comprising of ventilation vanes or louvers) or heating means can be provided on the first inner lid 1140,
the means 1170 of locking the inner lid to the main lid 1130 is formed in particular by a movable latch 1173 that engages with a counter-form 1134, but other locking principles can also be provided (flexible brackets, ¼-turn interface, bayonet, etc.),
the protruding counter-form 1134 can instead be a hole or a recessed shape
since each inner lid 1140, 1150, 1160 carries specific, dedicated members, the main lid 1130 can have a simple structure that easily accommodates each of the inner lids.

### INDUSTRIAL APPLICATION

A food preparation appliance according to the present disclosure, and the manufacture thereof, are suitable for industrial application.

1. A food preparation appliance comprising-of:
a housing,
a work bowl, defining a workspace configured to receive food to be prepared,
a main lid, configured to be moved between an open position and a closed position to respectively open and close the workspace,
at least one inner lid configured to be reversibly mounted on the main lid (20) and comprising at least one handling interface to enable a user to grasp or hold the inner lid,
wherein the handling interface on the inner lid mounted on the main lid is arranged at least partially outside the workspace when the main lid is in the closed position.

2. The food preparation appliance according to claim 1, wherein the handling interface comprises at least one handle.

3. The food preparation appliance according to claim 1, further comprising means for locking the inner lid to the main lid.

4. The food preparation appliance according to claim 1, wherein the handling interface is configured to lock the inner lid to the main lid.

5. The food preparation appliance according to claim 3, further comprising:
two locking devices arranged on either side of said one of the inner lid and the main lid and
two counter-forms each opposite, each locking device on the other of the inner lid and the main lid.

6. The food preparation appliance according to claim 5, wherein the main lid (20) comprises a lid frame, and wherein the two counter-forms opposite each locking device are formed by a rim of the lid frame.

7. The food preparation appliance according to any of claims 1, comprising a device for locking the main lid to the housing and/or the work bowl.

8. The food preparation appliance according to claim 7, wherein the inner lid comprises at least one radial bracket supporting at least one handling interface,
wherein the main lid locking device is configured to be moved between:
a main lid unlocked position, wherein the main lid is configured to move freely between the open position thereof and the closed position thereof,
a main lid locked position, wherein the main lid is locked in the closed position thereof,
and wherein the main lid locking device comprises at least one through opening configured to allow said at least one radial bracket to pass therethrough.

9. The food preparation appliance according to claim 8, wherein the main lid locking device comprises a rotatable lock ring comprising a plurality of locking teeth arranged to mate with the housing and/or the work bowl when the locking device is in the locked position.

10. The food preparation appliance according to 8, wherein, in one direction of travel between the main lid unlocked position and the main lid locked position:
the at least one through opening has a passage size greater than or equal to a size of said at least one radial bracket added to a range of travel of the main lid locking device between the main lid unlocked position and the main lid locked position.

11. The food preparation appliance according to claim 8, wherein the main lid locking device is configured to rotationally move around an axial direction of the work bowl between the main lid unlocked position and the main lid locked position.

12. The food preparation appliance according to claim 1, wherein the inner lid comprises a sealing means configured to enable pressure cooking in the workspace closed by the main lid fitted with the inner lid.

13. The food preparation appliance according to claim 1, wherein the inner lid comprises a pressure control means configured to open a pressure release valve if a pressure in the workspace is greater than or equal to a predetermined working pressure.

14. The food preparation appliance according to claim 1, wherein the main lid comprises a lid heating means configured to heat food received in the workspace when the inner lid is removed from the main lid.

15. The food preparation appliance according to claim 14, comprising a safety device configured to prevent operation of the lid heating means when the inner lid is mounted on the main lid or if the main lid is in the open position.

16. The food preparation appliance according to claim 9, wherein the at least one through opening is provided between two of the plurality of locking teeth.

17. The food preparation appliance according to claim 2, wherein the at least one handle comprises two handles.
